(19) United States
(12) Patent Application Publication
(10) Pub. No.: US 2005/0241444 A1
(43) Pub. Date: Nov. 3, 2005

(54) Orientation adjustable spanner

(76) Inventor: Chih-Ching Hsien, Taichung Hsien (TW)

Correspondence Address: Chih-Ching Hsien, 235 Chung-Ho, Box 8-24, Taipei, TW

(21) Appl. No.: 11/175,841

(22) Filed: Jul. 6, 2005

Related U.S. Application Data
(63) Continuation-in-part of application No. 10/118,172, filed on Apr. 9, 2002, now abandoned.

(51) Int. Cl. B25B 23/16

(52) U.S. Cl. 81/177.7

(57) ABSTRACT

A spanner comprises a driving head and a second pivotal portion; the driving head having an engaging portion for engaging screws; and the handle being capable of being held, thereby, the user can apply a force thereon. One end of the driving head has a first pivotal portion and one end of the handle has a second pivotal portion. The first pivotal portion and second pivotal portion are pivotally connectable for adjusting a respective orientation between the driving head and the handle. The holding area of the handle is larger than the prior art and thus the user can apply force to the handle easily. Moreover, the orientation of the handle respective the driving head is adjustable.

The present invention is a continuous in part of the U.S. patent application with Ser. No. 10/118,172 which is assigned to the inventor and applicant of the present invention. Thus, the contents of the application with Ser. No. 10,118,172 are incorporated into the present invention as a part of the specification of the present invention.

### FIELD OF THE INVENTION

The present invention relates to spanners, and particularly to an orientation adjustable spanner.

### BACKGROUND OF THE INVENTION

Spanners are necessary devices for engaging or disengaging screw means. FIGS. 1 to 3 show various types of prior art spanners. These prior art spanners have engaging portions for engaging with screw means. The handles of these spanners have the same structures. This prior art handle has a thin plate-like structure and is connected to the engaging portion with the plate surfaces of the handle being parallel to the plane of the engaging portion. It is often that the user can not hold the spanner conveniently. Moreover, since the two surfaces of the handle having larger area than the other two surfaces of the handle are parallel to the surface of the spanner, the force can not be applied conveniently and effectively.

Referring to FIG. 4, an easily force-applied spanner is illustrated. FIG. 4 shows a spanner with two engaging portions, wherein the middle portion of the handle is bent through 90 degrees. However, this design can not fully dissolve the prior art problems. Although farther section of the handle is vertical to one respective engaging portion, it is often that if the user holds this portion, the user will feel inconveniently. Moreover, the manufacturing work is complicated.

### SUMMARY OF THE INVENTION

Accordingly, the primary object of the present invention is to provide a spanner which can be assembled easily. The time period and labor required are less than the prior art.

Another object of the present invention is to provide a spanner, wherein force can be transferred more accurately. No efficiency loss occurs.

To achieve above object, the present invention provides spanner comprising a driving head and a handle; the driving head having an engaging portion for engaging screws; and the handle being capable of being held, thereby, the user can apply a force thereon. One end of the driving head has a first pivotal portion and one end of the handle has a second pivotal portion; the first pivotal portion and second pivotal portion are pivotally connectable for adjusting a respective orientation between the driving head and the handle.

The various objects and advantages of the present invention will be more readily understood from the following detailed description when read in conjunction with the appended drawing.

### BRIEF DESCRIPTION OF THE DRAWINGS

FIG. 1 is a schematic view of a prior art.

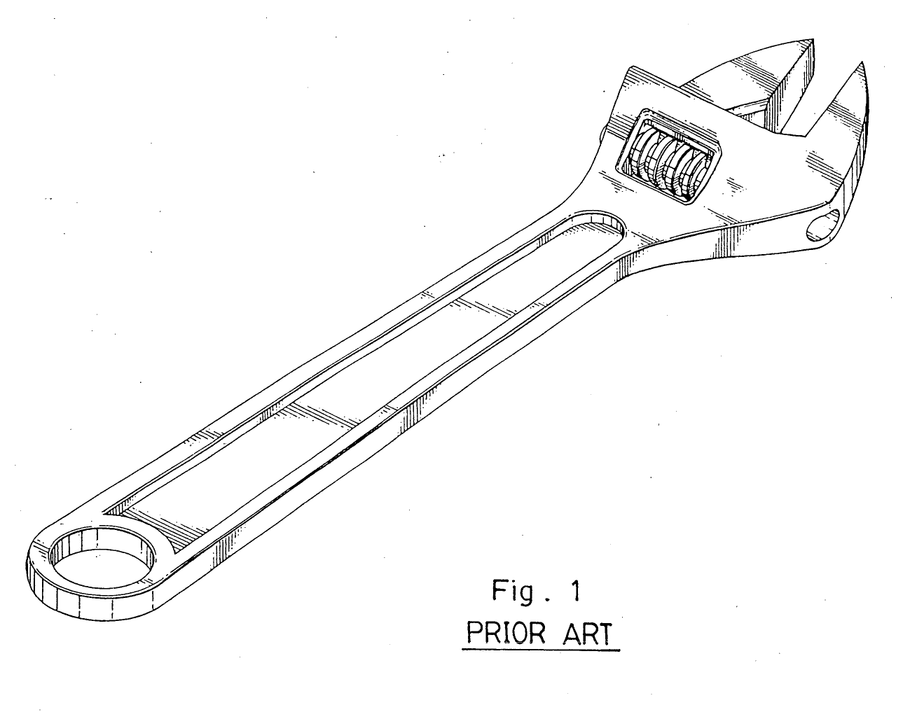

FIG. 2 is a schematic view of another prior art.

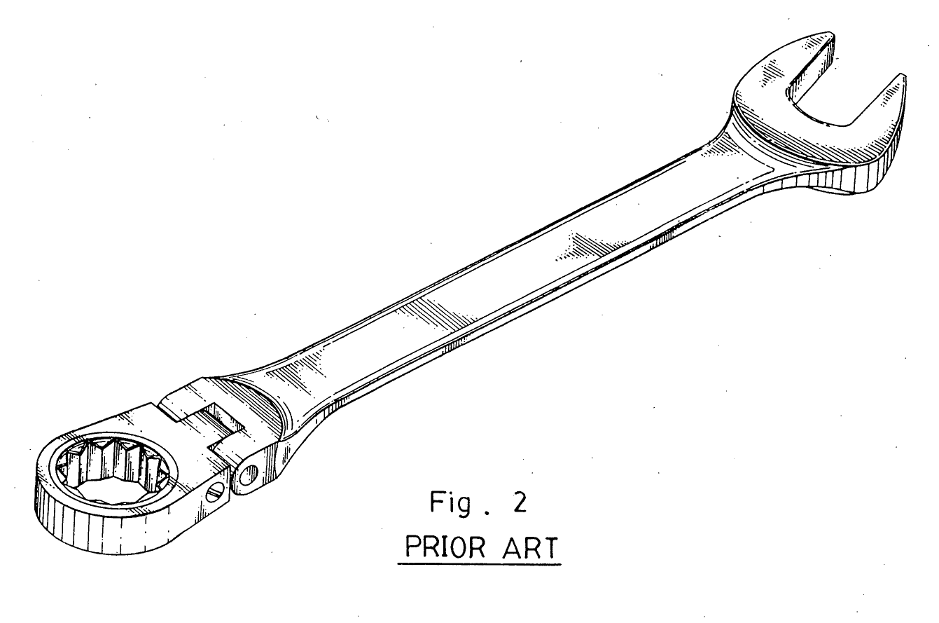

FIG. 3 is a schematic view of a third prior art.

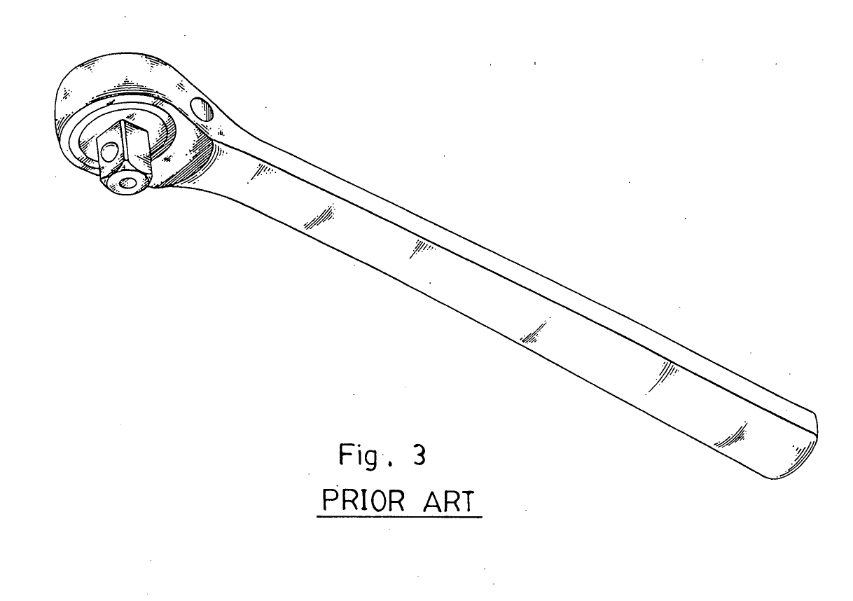

FIG. 4 is a schematic view of a fourth prior art.

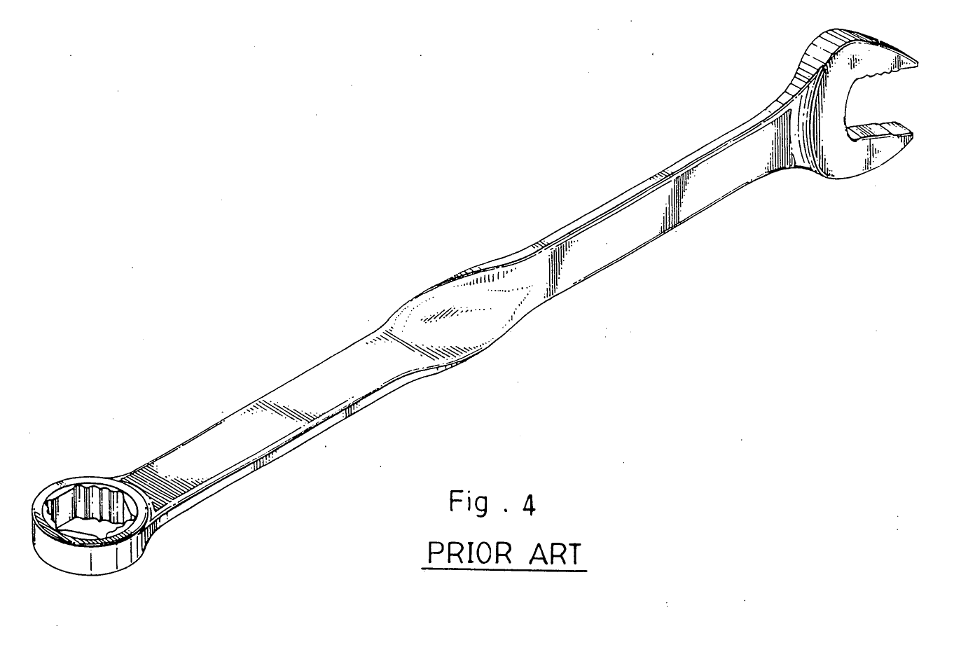

FIG. 5 is an assembled view of the present invention.

FIG. 6 is an exploded perspective view of the present invention.

FIG. 7 is a schematic view showing the orientation adjustment of the present invention.

FIG. 8 is a schematic view showing the holding operation of the present invention.

FIG. 9 is a schematic perspective view of the second embodiment of the present invention.

FIG. 10 is a schematic view showing that the present invention is used to an opened spanner.

FIG. 11 is another schematic perspective view of the opened spanner according to the present invention.

FIG. 12 is a schematic perspective view showing that the present invention is used to a socket spanner.

FIG. 13 is another schematic perspective view of the socket spanner according to the present invention.

### DETAILED DESCRIPTION OF THE PREFERRED EMBODIMENTS

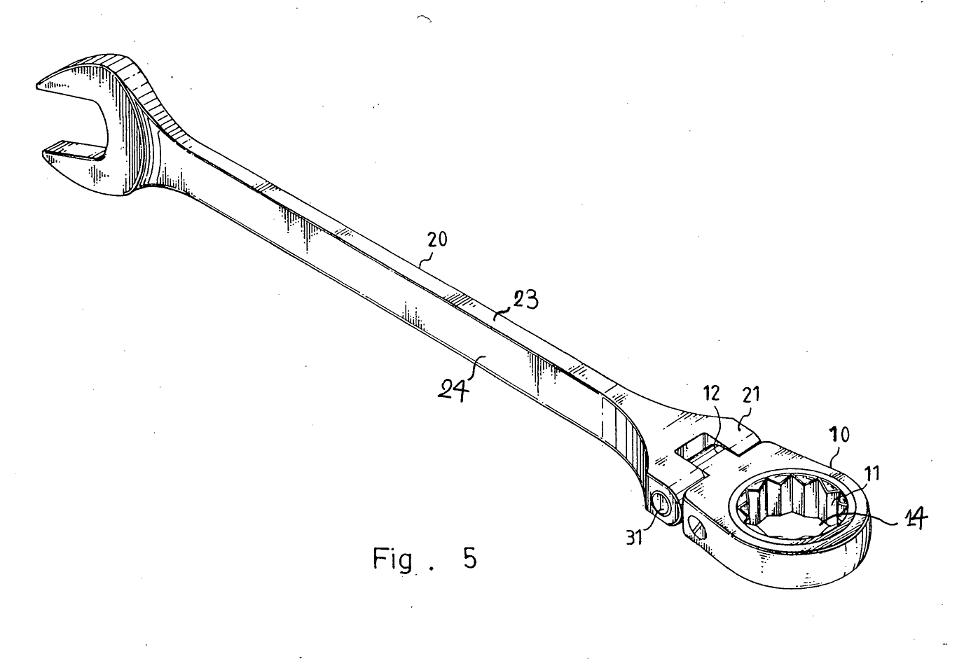

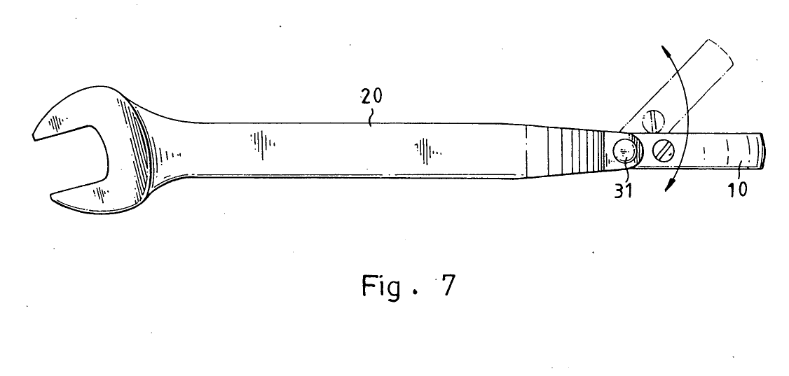

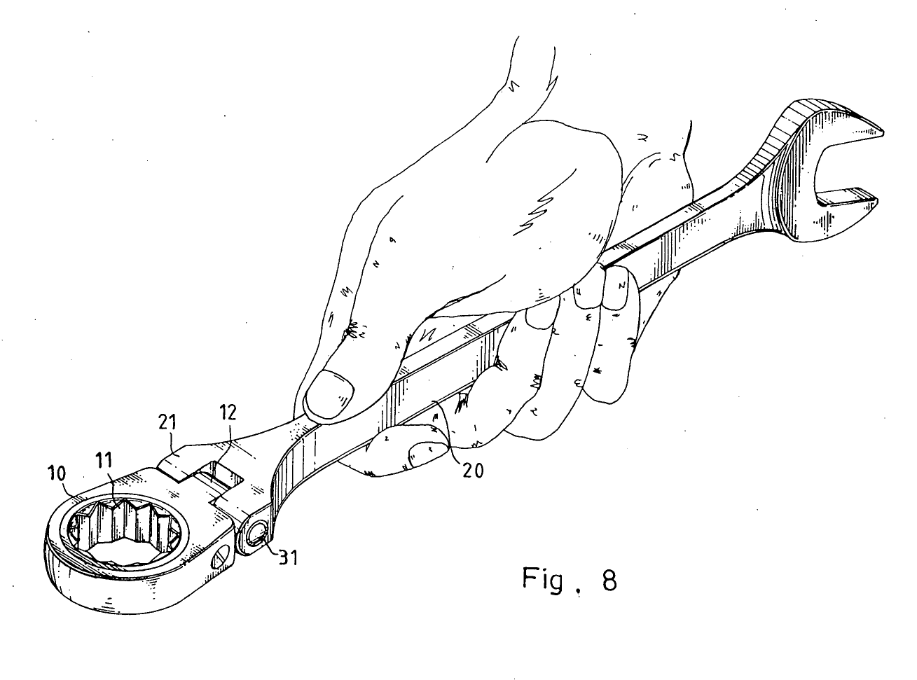

Referring to FIGS. 5 to 8, the first embodiment of the spanner of the present invention is illustrated.

A spanner comprises a driving head 10 having a ring portion 14 for engaging screws. One end of the driving head 10 has a first pivotal portion 12. The first pivotal portion 12 is protruded from the ring portion 14 of the driving head 10. A handle 20 is capable of being held. One end of the handle 20 has a second pivotal portion 21 which has a U shape for receiving the protruded first pivotal portion 12.

A cross section of the handle have an oblong shape which is formed by two parallel long sides 22 and two parallel short sides 23; and the two parallel sides are vertical to a surface formed by the ring portion 14 of the driving head 10. The first pivotal portion 12 and second pivotal portion 21 are pivotally connectable for adjusting a respective orientation between the driving head 10 and the handle 20. Thereby the use can operate the spanner conveniently with less force for driving a screw by the spanner.

As illustrated in the drawings, another end of the handle is formed as an opened spanner 30 for clamping another screw.

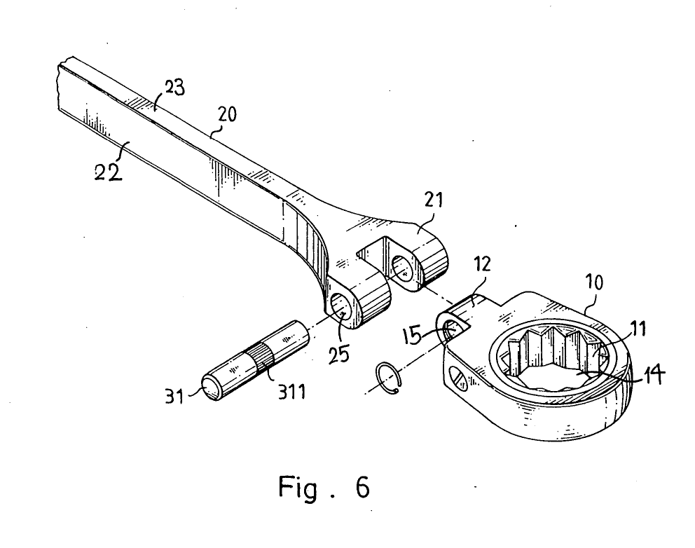

Furthermore, Referring to FIG. 6, the first pivotal portion has a hole 15 and the second pivotal portion has two holes 25. A shaft 31 passes through the hole 15 of the first pivotal portion 12 and the holes 25 of the second pivotal portion to connect the driving head 10 to the handle 20. A middle section 311 of the shaft 31 is textured for enhancing the tightening of the connection between the driving head 10 and handle 20.

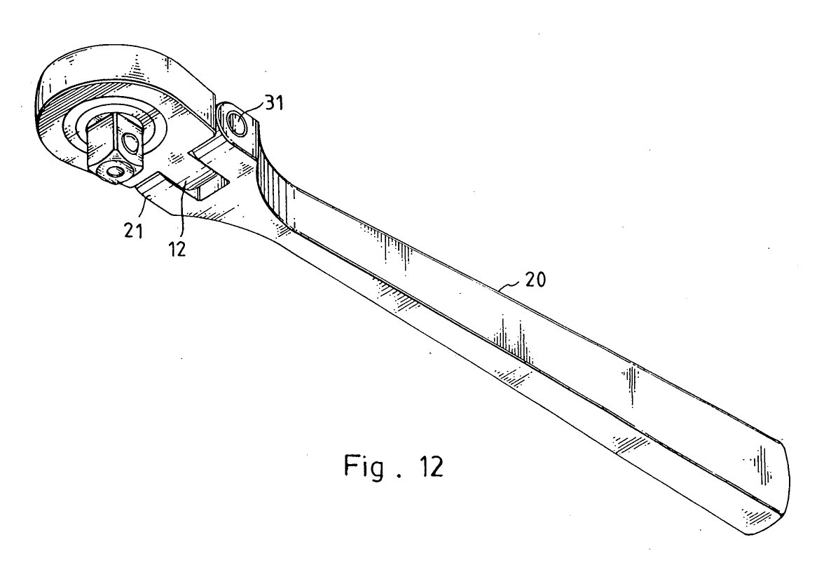

Moreover, in the present invention, the ring portion is used to drive a screw directly or as illustrated in FIG. 12, the ring portion is used to drive a socket.

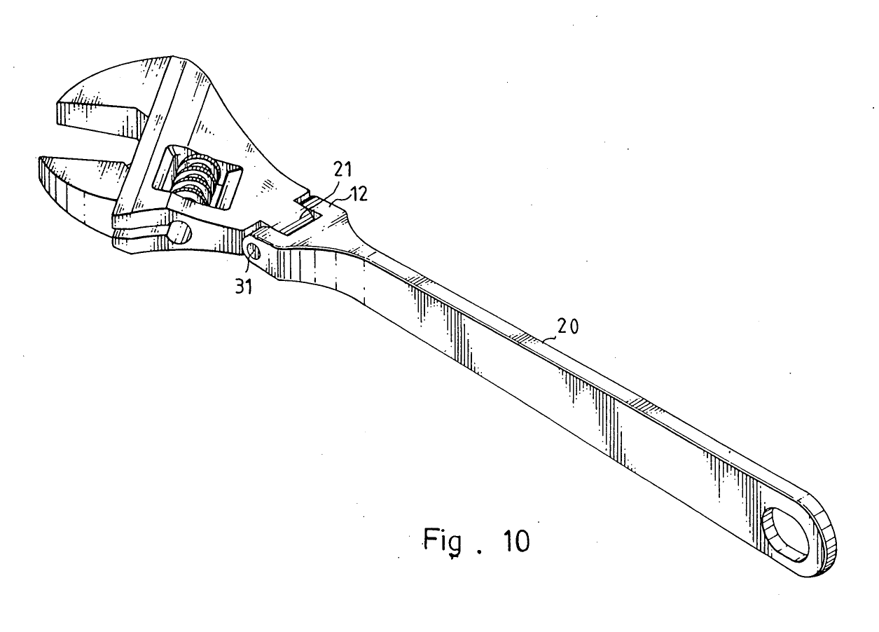

In FIG. 10, it is illustrated that another embodiment of the present invention, where the ring portion is replaced by an adjustable spanner which is suitable for different sizes of screws by adjusting-the opening of the adjusting spanner.

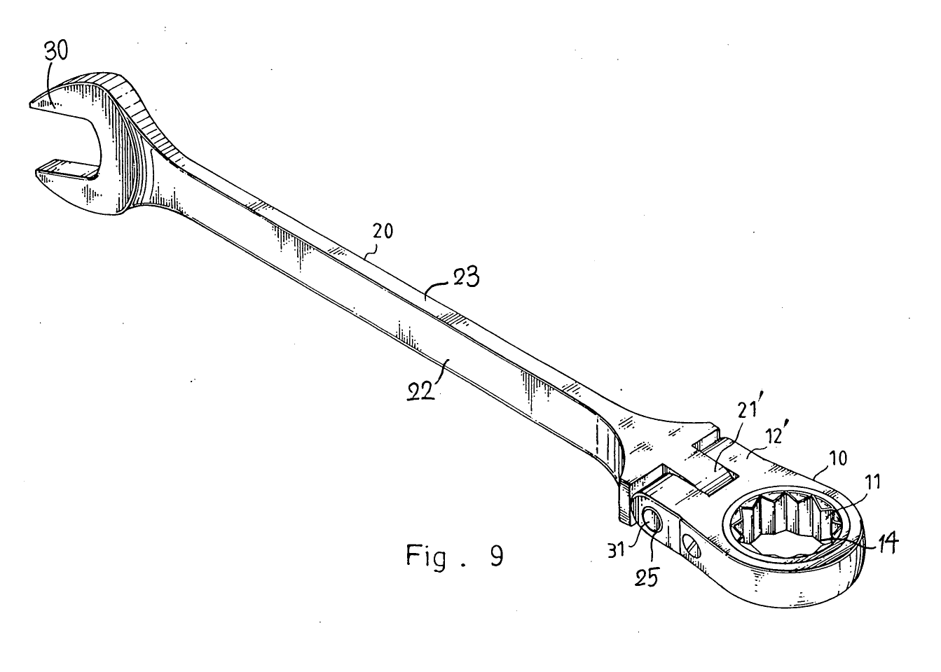

Referring to FIG. 9, another embodiment of the present invention is illustrated. Those identical to the first embodiment will not be further described. Only those different in the first and this embodiments are illustrated. In this embodiment, one end of the driving head 10 having a first pivotal portion 12′ and the first pivotal portion 12′ having a U shape portion. One end of the handle 20 having a second pivotal portion 21′ which is protruded from a body of the handle so as to be received in the U shape portion of the first pivotal portion 12′.

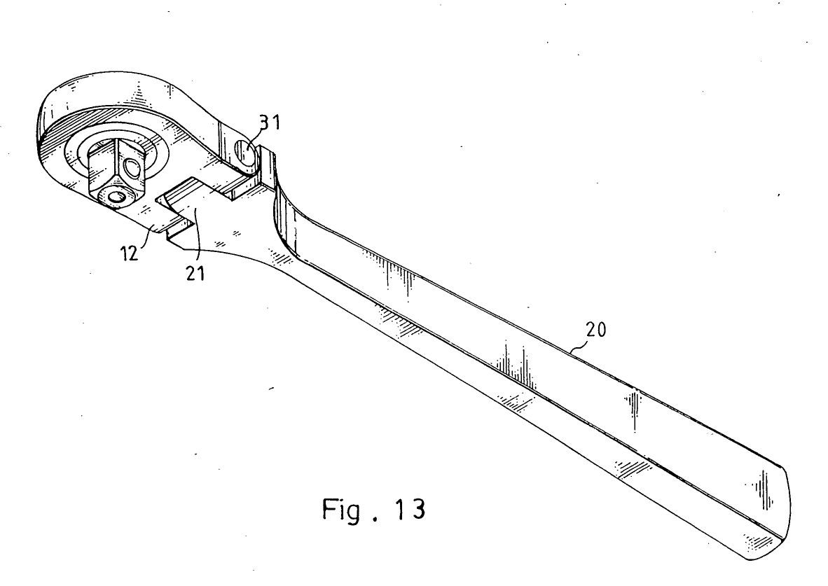

Referring to FIG. 9, in the present invention, the ring portion is used to drive a screw directly, or as illustrated in FIG. 13, the ring portion is used to drive a socket.

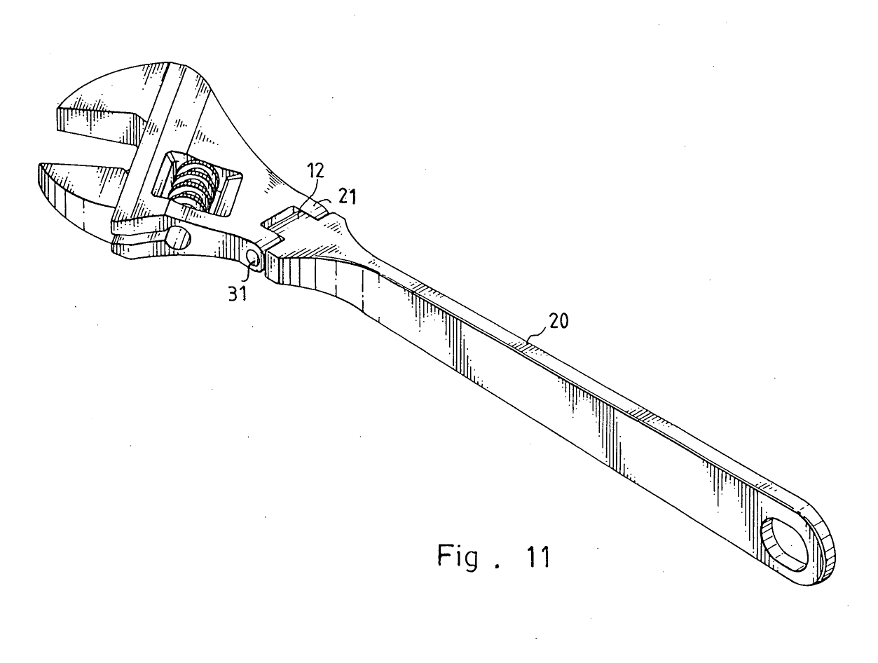

In FIG. 11, it is illustrated that another embodiment of the present invention, where the ring portion is replaced by an adjustable spanner which is suitable for different sizes of screws by adjusting the opening of the adjusting spanner.

In summary, the feature of the present invention will be described in the following:

1. The present invention can be assembled easily, in assembly, the first pivotal portion 12 of the driving head 10 is pivotally connected to the second pivotal portion 21 of the handle 20 by using the pivotal shaft 31 to pass through the two pivotal portions 12, 21. The time period and labor required are less than the prior art.

2. It has a preferred structure, no stress is concentrated and no structure is damaged. In the present invention, the second pivotal portion 21 and the handle 20 are formed integrally, and the second pivotal portion 21 is directly pivotally connected to the driving head 10. The force can be transferred more accurately. No efficiency loss occurs.

3. The present invention can be used in many different fields. The holding area of the handle is larger than the prior art and thus the user can apply force to the handle easily. Moreover, the orientation of the handle to the driving head is adjustable.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A spanner comprising
a driving head (10) having a ring portion (14) for engaging screws; one end of the driving head (10) having a first pivotal portion (12); the first pivotal portion (12) being protruded from the ring portion (14) of the driving head (10);
a handle (20), one end of the handle (20) having a second pivotal portion (21) which has a U shape for receiving the protruded first pivotal portion (12);
wherein a cross section of the handle have an oblong shape which is formed by two parallel long sides (22) and two parallel short sides (23); the two parallel sides are vertical to a surface formed by the ring portion (14) of the driving head (10);
wherein the first pivotal portion (12) and second pivotal portion (21) are pivotally connectable for adjusting a respective orientation between the driving head (10) and the handle (20).

2. The spanner as claimed in claim 1, wherein another end of the handle is formed as an opened spanner (30) for clamping another screw.

3. The spanner as claimed in claim 1, wherein the first pivotal portion has a hole (15) and the second pivotal portion has two holes (25); a shaft (31) passes through the hole (15) of the first pivotal portion (12) and the holes (25) of the second pivotal portion to connect the driving head 10 to the handle (20); and a middle section (311) of the shaft (31) is textured for enhancing the tightening of the connection between the driving head (10) and handle (20).

4. The spanner as claimed in claim 2, wherein the first pivotal portion has a hole (15) and the second pivotal portion has two holes (25); a shaft 31 passes through the hole 15 of the first pivotal portion (12) and the holes (25) of the second pivotal portion to connect the driving head (10) to the handle (20); a middle section (311) of the shaft (31) is textured for enhancing the tightening of the connection between the driving head (10) and handle (20).

5. The spanner as claimed in claim 1, wherein the ring portion (14) is used to drive a screw directly.

6. The spanner as claimed in claim 1, wherein the ring portion (14) is used to drive a socket.

7. A spanner comprising
a driving head (10) having a ring portion (14) for engaging screws; one end of the driving head (10) having a first pivotal portion (12′); the first pivotal portion (12′) having a U shape portion;
a handle (20), one end of the handle (20) having a second pivotal portion (21′) which is protruded from a body of the handle so as to be received in the U shape portion of the first pivotal portion (12′);
wherein a cross section of the handle have an oblong shape which is formed by two parallel long sides (22) and two parallel short sides (23); the two parallel sides are vertical to a surface formed by the ring portion (14) of the driving head (10);
wherein the first pivotal portion (12) and second pivotal portion (21) are pivotally connectable for adjusting a respective orientation between the driving head (10) and the handle (20).

8. The spanner as claimed in claim 7, wherein another end of the handle is formed as an opened spanner for clamping another screw.

9. The spanner as claimed in claim 7, wherein the first pivotal portion has two holes and the second pivotal portion has a hole; a shaft passes through the holes of the first pivotal portion and the hole of the second pivotal portion to connect the driving head to the handle; and a middle section of the shaft is textured for enhancing the tightening of the connection between the driving head and handle.

10. The spanner as claimed in claim 8, wherein the first pivotal portion has two holes and the second pivotal portion has a hole; a shaft passes through the holes of the first pivotal portion and the hole of the second pivotal portion to connect the driving head to the handle; and a middle section of the shaft is textured for enhancing the tightening of the connection between the driving head and handle.

11. The spanner as claimed in claim 7, wherein the ring portion is used to drive a screw directly.

12. The spanner as claimed in claim 7, wherein the ring portion is used to drive a socket.

13. A spanner comprising
a driving head having an adjustable end for engaging screws of different sizes; one end of the driving head having a first pivotal portion; the first pivotal portion being protruded from the adjustable end of the driving head;
a handle capable of being held, one end of the handle having a second pivotal portion which has a U shape for receiving the protruded first pivotal portion;
wherein a cross section of the handle have an oblong shape which is formed by two parallel long sides and two parallel short sides; the two parallel sides are vertical to a surface formed by the adjustable end of the driving head;
wherein the first pivotal portion and second pivotal portion are pivotally connectable for adjusting a respective orientation between the driving head 10 and the handle.
